(19) United States
(12) Patent Application Publication
(10) Pub. No.: US 2015/0156304 A1
(43) Pub. Date: Jun. 4, 2015

(54) Electronic Device And Information Processing Method

(71) Applicant: LENOVO (BEIJING) CO., LTD., Beijing (CN)

(72) Inventor: Chuanfeng Wang, Haidian District (CN)

(73) Assignee: LENOVO (BEIJING) CO., LTD., Beijing (CN)

(21) Appl. No.: 14/348,101

(22) PCT Filed: Jul. 5, 2013
(86) PCT No.: PCT/CN2013/078851

§ 371 Date: Mar. 28, 2014

(30) Foreign Application Priority Data
Jul. 5, 2012 (CN) 201210231718.2

(51) Int. Cl. H04M 1/725; H04M 1/02

(52) U.S. Cl. CPC H04M 1/72527; H04M 1/0254

(57) ABSTRACT

An electronic device and an information processing method are described. The device includes a first body, a first rotary structure connected to the first body, a support member comprising a first end and a second end, wherein the first end is connected to the first rotary structure, a second rotary structure connected to the second end, and a second body connected to the second rotary structure. When it is detected that the first body and the first rotary structure are separated and/or the second body and the second rotary structure are separated, switching the electronic device to the first operation mode; and when it is detected that the first body and the first rotary structure are connected and the second body and the second rotary structure are connected, switching the electronic device to the second operation mode.

### BACKGROUND

The present disclosure relates to a field of information processing, in particular to an electronic device and an information processing method.

With the development of computer technology, more and more electronic devices enter into people's life, from a desk computer to a notebook computer and further to tablet devices being popular in recent years, such as a tablet personal computer, a mobile phone, a MP3 and the like, which are smaller and smaller and are provided with basic functions needed for entertainments and work. Therefore, these electronic devices are popular among the masses of users.

At present, a majority of tablet personal computers in the market are similar in product functions and forms. People have made diversities of improvements to appearance and structure of the tablet devices. For example, a tablet device and an entity keyboard are made into a device with a slider at one side such as a structure of Nokia N97, and the tablet device is connected to the keyboard through a supporter. In a using process of a user, if the user wants to use the entity keyboard to input, the part of the entity keyboard can be presented through sliding the tablet device to a side; if the user wants to use a virtual keyboard in the tablet device to input, the part of the entity keyboard can be hidden through sliding the tablet device back.

However, in a process of implementing technical solutions of embodiments of the present disclosure, the inventor of the present application finds that the above technology has at least the following technical problems:

1. Since the supporter connected between the tablet device and the entity keyboard are not removable, the user cannot separate the tablet device or the entity keyboard from the supporter, which thus causes a technical problem that the user cannot switch the electronic device between a tablet personal computer operation mode and a notebook computer operation mode through separating or connecting the tablet device or the entity device from or to the supporter.

2. Since the tablet device and the entity keyboard are connected using the supporter which is not removable, the user needs to carry the entire electronic device when going outside regardless of whether the entity keyboard is needed to be used or not, which thus causes a technical problem of inconvenient carrying.

### SUMMARY

The present disclosure provides an electronic device and an information processing method used to solve the technical problem existing in the prior art that the electronic device cannot be switched between a tablet personal computer operation mode and a notebook computer operation mode through separating or connecting the tablet device or the entity device from or to the supporter.

In an embodiment of the present disclosure, there is provided an electronic device having a first operation mode and a second operation mode, comprising: a first body; a first rotary structure connected to the first body; a support member comprising a first end and a second end, wherein the first end is connected to the first rotary structure; a second rotary structure connected to the second end; a second body connected to the second rotary structure; wherein the electronic device is in the first operation mode when the first body and the first rotary structure are separated and/or the second body and the second rotary structure are separated; the electronic device is in the second operation mode when the first body and the first rotary structure are connected and the second body and the second rotary structure are connected.

Optionally, the electronic device further comprises: a first detecting unit set on the first body or the second body for detecting whether the first body is connected to the first rotary structure; a second detecting unit set on the first body or the second body for detecting whether the second body is connected to the second rotary structure; wherein the first detecting unit and the second detecting unit are same or different detecting units.

Optionally, the first body further comprises: a display unit for displaying at least one operation interface.

Optionally, the first body further comprises: a state switching unit for switching an operation mode of the electronic device to the first operation mode when the first body and the first rotary structure are separated and/or the second body and the second rotary structure are separated and for switching the operation mode of the electronic device to the second operation mode when the first body and the first rotary structure are connected and the second body and the second rotary structure are connected.

Optionally, the second body comprises: a power supply unit for supplying power to the first body when the first body and the first rotary structure are connected and the second body and the second rotary structure are connected.

Optionally, when the first operation mode is in particular a tablet personal computer operation mode, the electronic device further comprises: a touch sensing unit set on the first body for being in an enabled state when the first body and the first rotary structure are separated and/or the second body and the second rotary structure are separated;

Optionally, when the second operation mode is in particular a notebook computer operation mode, the electronic device further comprises: an input unit set on the second body for being in an enabled state when the first body and the first rotary structure are connected and the second body and the second rotary structure are connected.

Optionally, the electronic device further comprises: a first data transmitting unit set on the first body; a second data transmitting unit matching with the first data transmitting unit and set on the second body; wherein data transmission is realized between the first body and the second body through the first data transmitting unit and the second data transmitting unit.

In another embodiment of the present disclosure, there is provided an information processing method applicable to an electronic device comprising a first body; a first rotary structure connected to the first body; a support member comprising a first end and a second end, wherein the first end is connected to the first rotary structure; a second rotary structure connected to the second end; and a second body connected to the second rotary structure, comprising: detecting whether the first body is connected to the first rotary structure; detecting whether the second body is connected to the second rotary structure; switching an operation mode of the electronic device to a first operation mode when it is detected that the first body and the first rotary structure are separated and/or the second body and the second rotary structure are separated; switching the operation mode of the electronic device to a second operation mode when it is detected that the first body and the first rotary structure are connected and the second body and the second rotary structure are connected.

Optionally, said detecting whether the first body is connected to the first rotary structure in particular comprises: detecting whether the first body is connected to the first rotary structure and obtaining a first detecting result; and sending the first detecting result to the first body.

Optionally, said detecting whether the second body is connected to the second rotary structure in particular comprises: detecting whether the second body is connected to the second rotary structure and obtaining a second detecting result; and sending the second detecting result to the first body.

Optionally, said switching an operation mode of the electronic device to a first operation mode when it is detected that the first body and the first rotary structure are separated and/or the second body and the second rotary structure are separated in particular comprises: generating a first state switching prompt window; detecting whether there is an operation for the first state switching prompt widow; and switching the first body to the first operation mode based on the operation.

Optionally, said switching the operation mode of the electronic device to a second operation mode when it is detected that the first body and the first rotary structure are connected and the second body and the second rotary structure are connected in particular comprises: generating a second state switching prompt window; detecting whether there is an operation for the second state switching prompt widow; and switching the first body to the second operation mode based on the operation.

Optionally, said switching an operation mode of the first body to the first operation mode based on the operation in particular comprises: switching the operation mode of the first body to the first operation mode when the operation is to determine switching to the first operation mode; maintaining the operation mode of the first body in the second operation mode when the operation is to cancel switching to the first operation mode.

Optionally, said switching an operation mode of the first body to the second operation mode based on the operation in particular comprises: switching the operation mode of the first body to the second operation mode when the operation is to determine switching to the second operation mode; maintaining the operation mode of the first body in the first operation mode when the operation is to cancel switching to the second operation mode.

Optionally, said switching an operation mode of the electronic device to a first operation mode in particular comprises: setting a touch sensing unit of the first body as being in an enabled state.

Optionally, said switching the operation mode of the electronic device to a second operation mode in particular comprises: setting a touch sensing unit of the first body as being in a disabled state, and/or setting an input unit of the second body as being in an enabled state.

One or more technical solutions provided in the embodiments of the present disclosure has at least the following technical effects or advantages:

1. A separable connecting structure is adopted, so that the user can separate the tablet device or the entity keyboard from the support member, which thus effectively solves the technical problem that the user cannot switch the electronic device between a tablet personal computer operation mode and a notebook computer operation mode through separating or connecting the tablet device or the entity device from or to the support member, so as to realize that the electronic device is switched between the tablet personal computer operation mode and the notebook computer operation mode.

2. A separable connecting structure is adopted, so that the user can only carry the tablet part and does not need to carry the entire side-sliding electronic device when the user goes out, which thus effectively solves the technical problem of inconvenient carrying of the side-sliding electronic device, so as to provide an electronic device which is more convenient to be carried and is more flexible in use manners.

3. When the first body and the first rotary structure are connected and the second body and the second rotary structure are connected, the second body is adopted to supply power to the first body, so that the user does not need to utilize an external power supply to specially supply power to the first body in the using process of the user, thus simplifying the power supply unit of the electronic device and further extending service time of the first body.

### BRIEF DESCRIPTION OF THE DRAWINGS

FIG. 1 is a diagram of a structure of an electronic device of an embodiment of the present application; and

FIG. 2 is a flowchart of an information processing method of another embodiment of the present application;

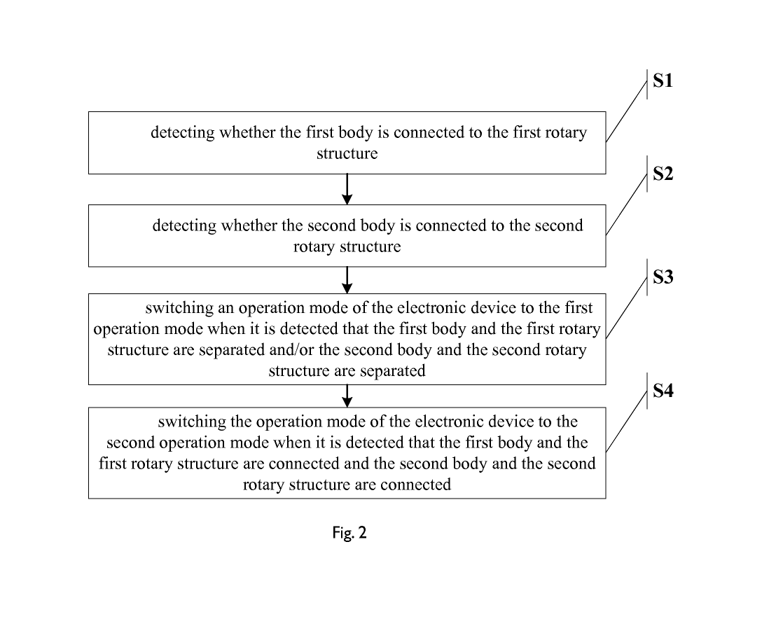

### DETAILED DESCRIPTION

In embodiments of the present disclosure, there are provided an electronic device and an information processing method used for solving the technical problem existing in the prior art that the user cannot switch the electronic device between a tablet personal computer operation mode and a notebook computer operation mode through separating or connecting the tablet device or the entity device from or to the supporter. In the technical solutions of the embodiments of the present application, the electronic device can be switched between the tablet personal computer operation mode and the notebook computer operation mode by separation or connection of the tablet device and the first rotary structure and separation or connection of the second rotary structure and the second body, so as to realize a fast switch of the operation mode of the electronic device.

In order to solve the problem of realizing the fast switch of the operation mode of the electronic device, the embodiments of the present disclosure have the following general concept: a first body; a first rotary structure connected to the first body; a support member comprising a first end and a second end, wherein the first end is connected to the first rotary structure; a second rotary structure connected to the second end; a second body connected to the second rotary structure; wherein the electronic device is in a first operation mode when the first body and the first rotary structure are separated and/or the second body and the second rotary structure are separated; the electronic device is in a second operation mode when the first body and the first rotary structure are connected and the second body and the second rotary structure are connected.

In order to better understand the above technical solution, below will be a detailed description of the above technical solution in combination with the accompanying drawings and the specific implementation modes of the specification.

In an embodiment of the present disclosure, there is provided an electronic device used for realizing a fast switch of an operation mode of the electronic device between a tablet personal computer operation mode and a notebook computer operation mode. The present embodiment takes the first operation mode being the table computer operation mode and the second operation mode being the notebook computer operation mode as an example.

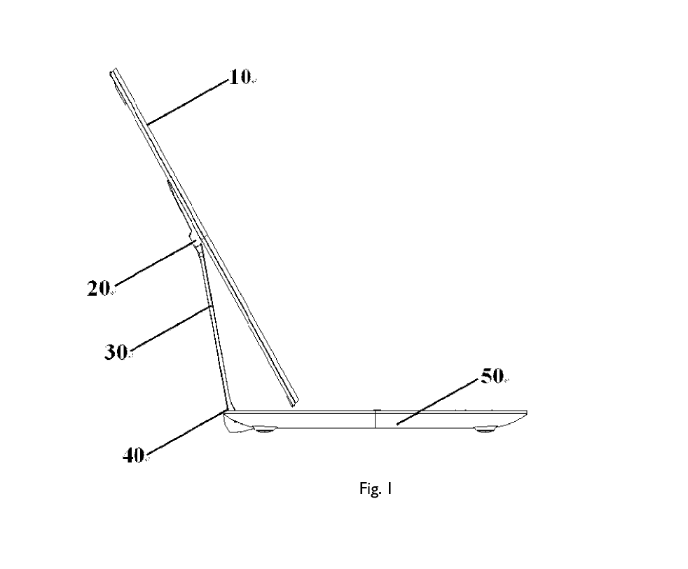

As shown in FIG. 1, the electronic device comprises: a first body 10; a first rotary structure 20 connected to the first body 10; a support member 30 comprising a first end and a second end, wherein the first end is connected to the first rotary structure 20; a second rotary structure 40 connected to the second end; a second body 50 connected to the second rotary structure 40; wherein the electronic device is in a first operation mode when the first body 10 and the first rotary structure 20 are separated and/or the second body 50 and the second rotary structure 40 are separated; the electronic device is in a second operation mode when the first body 10 and the first rotary structure 20 are connected and the second body 50 and the second rotary structure 40 are connected.

In the present embodiment, the first body 10 may be a tablet personal computer, the support member 30 is an empty cavity body, and the second body 50 may comprise an entity keyboard, of course may further comprise an input device such as a touch panel and the like, and may further comprise a touch display unit, i.e., the second body 50 may be a tablet personal computer, to which the present application does not limit.

In a specific implementation process, the first rotary structure 20 and the second rotary structure 40 may in particular be spindles, wherein the end where the first rotary structure 20 and the first body 10 are connected may be a standard I/O interface, such as a USB interface or a DOCK interface and the like, to which the present application does not limit. However, in the present embodiment, the first rotary structure 20 and the first body 10 are connected through a USB interface, and the second body 50 and the second rotary structure 40 are also connected through a USB interface.

Further, the electronic device further comprises: a first detecting unit set on the first body 10 or the second body 50 for detecting whether the first body 10 is connected to the first rotary structure 20; and a second detecting unit set on the first body 10 or the second body 50 for detecting whether the second body 50 is connected to the second rotary structure 40; wherein the first detecting unit and the second detecting unit are same or different detecting units.

In the present embodiment, the first detecting unit is a detecting unit being different from the second detecting unit, but both the first detecting unit and the second detecting unit are set on the first body. Of course, the first detecting unit and the second detecting unit may also be a same detecting unit set on the first body 10, or may be two detecting units set on the first body 10 or the second body 50 respectively, to which the present application does not particularly limit.

Further, the first body 10 further comprises: a display unit for displaying at least one operation interface.

Further, the first body 10 further comprises: a state switching unit for switching an operation mode of the electronic device to the first operation mode when the first body 10 and the first rotary structure 20 are separated and/or the second body 50 and the second rotary structure 40 are separated and for switching the operation mode of the electronic device to the second operation mode when the first body 10 and the first rotary structure 20 are connected and the second body 50 and the second rotary structure 40 are connected.

Further, the second body 50 comprises: a power supply unit for supplying power to the first body 10 when the first body 10 and the first rotary structure 20 are connected and the second body 50 and the second rotary structure 40 are connected.

In a specific implementation, power supplying of the second body 50 to the first body 10 is realized through power lines which are held within an empty cavity of the support member 30. A power path between the first body 10 and the second body 50 are established when the first body 10 is connected to the first rotary structure 20 through the USB interface and the second body 50 is connected to the second rotary structure 40 through the USB interface, thus power supplying of the second body 50 to the first body 10 can be realized.

Further, when the first operation mode is in particular the table personal computer operation mode, the electronic device further comprises: a touch sensing unit set on the first body 10 and being in an enabled state when the first body 10 and the first rotary structure 20 are separated and/or the second body 50 and the second rotary structure 40 are separated.

Further, when the second operation mode is in particular the notebook computer operation mode, the electronic device further comprises: an input unit set on the second body 50 and being in an enabled state when the first body 10 and the first rotary structure 20 are connected and the second body 50 and the second rotary structure 40 are connected.

In the present embodiment, the touch sensing unit may in particular be used to provide a virtual keyboard, and the input unit may in particular be an entity keyboard.

In particular, the electronic device is in the tablet personal computer operation mode when the first body 10 and the first rotary structure 20 are separated and/or the second body 50 and the second rotary structure 40 are separated. Then, the virtual keyboard on the first body 10 is in the enabled state, and the user can perform a click operation on the virtual keyboard; the electronic device is in the notebook computer operation mode when the first body 10 and the first rotary structure 20 are connected and the second body 50 and the second rotary structure 40 are connected. Then, the entity keyboard on the second body 50 is in the enabled stated, and the user can perform an input operation through the entity keyboard. At the same time, the virtual keyboard on the first body 10 may be in the enabled state or in a disabled state. In the present embodiment, the virtual keyboard is in the disabled state when the entity keyboard is in the enabled state.

Further, the electronic device further comprises: a first data transmitting unit set on the first body 10; a second data transmitting unit matching with the first data transmitting unit and set on the second body 50; wherein data transmission between the first body 10 and the second body 50 is realized through the first data transmitting unit and the second data transmitting unit.

In the present embodiment, regardless of whether the first body 10 and the first rotary structure 20 are connected or separated and whether the second body 50 and the second rotary structure 40 are connected or separated, the first body 10 and the second body 50 perform wireless data transmission through the first data transmitting unit and the second data transmitting unit. Of course, communication between the first body 10 and the second body 50 may also be a wired data transmission, to which the present application does not limit.

Below will be a detailed specification of an operation process of the electronic device.

A first case is that the use needs to switch the electronic device to the tablet personal computer operation mode.

First, the user pulls out the first body 10 from the USB interface through which the first body 10 is connected with the first rotary structure 20. At this time, the first detecting unit detects that the first body 10 and the first rotary structure 20 are separated, and produces a first detecting result; and/or, the user pulls out the second rotary structure 40 from the USB interface through which the second rotary structure 40 is connected with the second body 50. At this time, the second detecting unit detects that the second body 50 and the second rotary structure 40 are separated, and produces a second detecting result.

Then, the obtained first detecting result and second detecting result are transmitted to the state switching unit set on the first body 10 which generates a first state switching prompt window, for example, the window displays “confirm whether to switch to the tablet personal computer operation mode?” and displays two icons of “confirm” and “cancel”.

Next, after the user clicks the “confirm” icon, the first detecting unit will detect this operation and generate a first control instruction to be transmitted to the state switching unit, such that the virtual keyboard on the first body 10 is in the enabled state, so as to further realize that the electronic device is switched to the tablet computer operation mode.

In another implementation, the user may not need to switch the operation mode of the electronic device, and then the user will select to click the “cancel” icon. After the user clicks the “cancel” icon, the first detecting unit detects this operation, but neither generates any control instruction, nor triggers any function, such that the electronic device is kept in the notebook computer operation mode.

Further, the support member 30 may be used as a supporter when the first body 10 and the first rotary structure 20 are connected and the second body 50 and the second rotary structure 40 are separated, so that the first body 10 is supported when the user singly uses the first body 10.

A second case is that the user needs to switch the electronic device to the notebook computer operation mode.

First, the user engages the first body 10 to the USB interface through which the first body 10 is connected to the first rotary structure 20. At this time, the first detecting unit detects that the first body 10 and the first rotary structure 20 are connected and produces a first detecting result; further, the user engages the second rotary structure 40 to the USB interface through which the second rotary structure 40 is connected to the second body 50. At this time, the second detecting unit detects that the second body 50 and the second rotary structure 40 are connected and produces a second detecting result.

Then, the obtained first detecting result and second detecting result are transmitted to the state switching unit set on the first body 10 which generates a second state switching prompt window, for example, the window displays “confirm whether to switch to the notebook computer operation mode?” and displays two icons of “confirm” and “cancel”.

Next, after the user clicks the “confirm” icon, the first detecting unit will detect this operation and generates a first control instruction to be transmitted to the state switching unit, such that the virtual keyboard on the first body 10 is in the disabled state and the entity keyboard on the second body 50 is in the enabled state, so as to further realize that the electronic device is switched to the notebook computer operation mode.

In another embodiment, the user may not need to switch the operation mode of the electronic device, and then the user will select to click the “cancel” icon. After the user clicks the “cancel” icon, the first detecting unit detects this operation, but neither generates any control instruction, nor triggers any function, such that the electronic device is kept in the tablet personal computer operation mode.

Further, the second body 50 realizes supplying power to the first body 10 through power lines held within the empty cavity of the support member 30 when the first body 10 and the first rotary structure 20 are connected and the second body 50 and the second rotary structure 40 are connected.

With the electronic device in the present embodiment, the operation mode switch of the electronic device can be controlled through connection or separation of the first body 10 and the first rotary structure 20 and/or connection or separation of the second body 50 and the second rotary structure 40. Further, when the state switch is performed, the user can determine whether or not to switch the operation mode of the electronic device according to his/her own actual needs, so as to further realize the fast switch of the electronic device between the tablet personal computer operation mode and the notebook computer operation mode.

In another embodiment of the present disclosure, there is provided an information processing method applicable to an electronic device comprising: a first body; a first rotary structure connected to the first body; a support member comprising a first end and a second end, wherein the first end is connected to the first rotary structure; a second rotary structure connected to the second end; and a second body connected to the second rotary structure, comprising:

Step S1: detecting whether the first body is connected to the first rotary structure;

Step S2: detecting whether the second body is connected to the second rotary structure;

Step S3: switching an operation mode of the electronic device to a first operation mode when it is detected that the first body and the first rotary structure are separated and/or the second body and the second rotary structure are separated;

Step S4: switching the operation mode of the electronic device to a second operation mode when it is detected that the first body and the first rotary structure are connected and the second body and the second rotary structure are connected.

Further, step S1 in particular comprises: detecting whether the first body is connected to the first rotary structure and obtaining a first detecting result; and sending the first detecting result to the first body.

Further, step S2 in particular comprises: detecting whether the second body is connected to the second rotary structure and obtaining a second detecting result; and sending the second detecting result to the first body.

Further, step S3 in particular comprises: generating a first state switching prompt window; detecting whether there is an operation for the first state switching prompt widow; and switching the first body to the first operation mode based on the operation.

Further, step S4 in particular comprises: generating a second state switching prompt window; detecting whether there is an operation for the second state switching prompt widow; and switching the first body to the second operation mode based on the operation.

Further, the step of switching an operation mode of the first body to the first operation mode based on the operation in particular comprises: switching the operation mode of the first body to the first operation mode when the operation is to determine switching to the first operation mode; and maintaining the operation mode of the first body in the second operation mode when the operation is to cancel switching to the first operation mode.

Further, the step of switching an operation mode of the first body to the second operation mode based on the operation in particular comprises: switching the operation mode of the first body to the second operation mode when the operation is to determine switching to the second operation mode; and maintaining the operation mode of the first body in the first operation mode when the operation is to cancel switching to the second operation mode.

Further, the step of switching an operation mode of the electronic device to a first operation mode in particular comprises: setting a touch sensing unit of the first body as being in an enabled state.

Further, the step of switching the operation mode of the electronic device to a second operation mode in particular comprises: setting a touch sensing unit of the first body as being in a disabled state, and/or setting an input unit of the second body as being in an enabled state.

The above-described respective embodiments describe the electronic device in details, and the information processing method in the present embodiment is implemented based on the electronic device in the embodiments described above. Therefore, according to the detailed description of the electronic device described above, those skilled in the art can clearly know how to implement the information processing method in the present embodiment, details omitted for the purpose of concision.

One or more technical solutions provided in the embodiments of the present disclosure has at least the following technical effects or advantages:

1. A separable connecting structure is adopted, so that the user can separate the tablet device or the entity keyboard from the support member, which thus effectively solves the technical problem in the prior art that the user cannot switch the electronic device between a tablet personal computer operation mode and a notebook computer operation mode through separating or connecting the tablet device or the entity device from or to the supporter, so as to realize that the electronic device is switched between the tablet personal computer operation mode and the notebook computer operation mode.

2. A separable connecting structure is adopted, so that the user can only carry the tablet part and does not need to carry the entire side-sliding device when the user goes out, which thus effectively solves the technical problem of inconvenient carrying of the side-sliding electronic device, so as to provide an electronic device which is more convenient to be carried and is more flexible in use manners.

3. When the first body and the first rotary structure are connected and the second body and the second rotary structure are connected, the second body is adopted to supply power to the first body, so that the user does not need to utilize an external power supply to specially supply power to the first body in the using process of the user, thus simplifying the power supply unit of the electronic device and further extending service time of the first body.

Although the preferred embodiments of the present disclosure have been described, those skilled in the art can make additional alternations and amendments to these embodiments once basic inventive concepts are known. Therefore, the claims intends to be explained as comprising preferred embodiments and all alternations and amendments that fall into the scope of the present disclosure.

Obviously, those skilled in the art can make various alternations and modifications to the present disclosure without departing from the spirit and scope of the present disclosure. As such, if these amendments and modifications of the present disclosure fall into the scope of the claims and their equivalent technology, the present disclosure intends to comprise these alternations and modifications.

1. An electronic device having a first operation mode and a second operation mode, comprising:
a first body;
a first rotary structure connected to the first body;
a support member comprising a first end and a second end, wherein the first end is connected to the first rotary structure;
a second rotary structure connected to the second end;
a second body connected to the second rotary structure;
wherein the electronic device is in the first operation mode when the first body and the first rotary structure are separated and/or the second body and the second rotary structure are separated; and the electronic device is in the second operation mode when the first body and the first rotary structure are connected and the second body and the second rotary structure are connected.

2. The electronic device as claimed in claim 1, further comprising:
a first detecting unit set on the first body or the second body for detecting whether the first body is connected to the first rotary structure;
a second detecting unit set on the first body or the second body for detecting whether the second body is connected to the second rotary structure;
wherein the first detecting unit and the second detecting unit are same or different detecting units.

3. The electronic device as claimed in claim 1, wherein the first body further comprises a display unit for displaying at least one operation interface.

4. The electronic device as claimed in claim 3, wherein the first body further comprises a state switching unit for switching an operation mode of the electronic device to the first operation mode when the first body and the first rotary structure are separated and/or the second body and the second rotary structure are separated and for switching the operation mode of the electronic device to the second operation mode when the first body and the first rotary structure are connected and the second body and the second rotary structure are connected.

5. The electronic device as claimed in claim 1, wherein the second body comprises a power supply unit for supplying power to the first body when the first body and the first rotary structure are connected and the second body and the second rotary structure are connected.

6. The electronic device as claimed in claim 1, wherein when the first operation mode is a tablet personal computer operation mode, the electronic device further comprises a touch sensing unit set on the first body and being in an enabled state when the first body and the first rotary structure are separated and/or the second body and the second rotary structure are separated.

7. The electronic device as claimed in claim 1, wherein when the second operation mode is a notebook computer operation mode, the electronic device further comprises an input unit set on the second body and being in an enabled state when the first body and the first rotary structure are connected and the second body and the second rotary structure are connected.

8. The electronic device as claimed in claim 1, wherein the electronic device further comprises:
a first data transmitting unit set on the first body;
a second data transmitting unit matching with the first data transmitting unit and set on the second body;
wherein data transmission is realized between the first body and the second body through the first data transmitting unit and the second data transmitting unit.

9. An information processing method applicable to an electronic device comprising a first body; a first rotary structure connected to the first body; a support member comprising a first end and a second end, wherein the first end is connected to the first rotary structure; a second rotary structure connected to the second end; and a second body connected to the second rotary structure, comprising:
detecting whether the first body is connected to the first rotary structure;
detecting whether the second body is connected to the second rotary structure;
switching an operation mode of the electronic device to a first operation mode when it is detected that the first body and the first rotary structure are separated and/or the second body and the second rotary structure are separated;
switching the operation mode of the electronic device to a second operation mode when it is detected that the first body and the first rotary structure are connected and the second body and the second rotary structure are connected.

10. The method as claimed in claim 9, wherein the detecting whether the first body is connected to the first rotary structure comprises:
detecting whether the first body is connected to the first rotary structure and obtaining a first detecting result; and
sending the first detecting result to the first body.

11. The method as claimed in claim 9, wherein the detecting whether the second body is connected to the second rotary structure comprises:
detecting whether the second body is connected to the second rotary structure and obtaining a second detecting result; and
sending the second detecting result to the first body.

12. The method as claimed in claim 9, wherein the switching an operation mode of the electronic device to a first operation mode when it is detected that the first body and the first rotary structure are separated and/or the second body and the second rotary structure are separated comprises:
generating a first state switching prompt window;
detecting whether there is an operation for the first state switching prompt widow; and
switching the first body to the first operation mode based on the operation.

13. The method as claimed in claim 9, wherein the switching the operation mode of the electronic device to a second operation mode when it is detected that the first body and the first rotary structure are connected and the second body and the second rotary structure are connected comprises:
generating a second state switching prompt window;
detecting whether there is an operation for the second state switching prompt widow; and
switching the first body to the second operation mode based on the operation.

14. The method as claimed in claim 12, wherein the switching an operation mode of the first body to the first operation mode based on the operation comprises:
switching the operation mode of the first body to the first operation mode when the operation is to determine switching to the first operation mode; and
maintaining the operation mode of the first body in the second operation mode when the operation is to cancel switching to the first operation mode.

15. The method as claimed in claim 13, wherein the switching the operation mode of the first body to the second operation mode based on the operation comprises:
switching the operation mode of the first body to the second operation mode when the operation is to determine switching to the second operation mode; and
maintaining the operation mode of the first body in the first operation mode when the operation is to cancel switching to the second operation mode.

16. The method as claimed in claim 9, wherein the said switching an operation mode of the electronic device to a first operation mode comprises setting a touch sensing unit of the first body as being in an enabled state.

17. The method as claimed in claim 9, wherein the switching the operation mode of the electronic device to a second operation mode comprises setting a touch sensing unit of the first body as being in a disabled state, and/or setting an input unit of the second body as being in an enabled state.
